(19) United States
(12) Patent Application Publication
(10) Pub. No.: US 2016/0170380 A1
(43) Pub. Date: Jun. 16, 2016

(54) Advancing Time Device

(71) Applicant: John Earl Edwards, Sparta, WI (US)

(72) Inventor: John Earl Edwards, Sparta, WI (US)

(21) Appl. No.: 14/568,100

(22) Filed: Dec. 11, 2014

(51) Int. Cl. G04G 15/00

(52) U.S. Cl. CPC G04G 15/00

(57) ABSTRACT

An advancing time device always either returns the current tine or the current time plus a random or fixed interval. It will never return a time earlier than the current time.

### CROSS-REFERENCE TO RELATED APPLICATIONS

This application claims the benefit of Applicants' prior provisional application, No. [61/91.4,960], filed on [Dec. 12, 2013]

### STATEMENT REGARDING FEDERALLY SPONSORED RESEARCH OR

### DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of Time

More particularly, the present invention is in the technical field of Time Tracking

### SUMMARY OF THE INVENTION

The present invention is an advancing time device used to track the current time, but possibly return a time that is ahead. It can, in random or fixed intervals set the time ahead by random or fixed intervals. For example if the current time is 3pm, the device might return 3:10pm. It would never return a time earlier that it really was. Using the example above, if it was 3pm, it would never return a time earlier than that like 2:30 pm.

### BRIEF DESCRIPTION OF THE DRAWINGS

FIG. 1 is a perspective view of a Flow Diagram of the present invention;

### DETAILED DESCRIPTION OF THE INVENTION

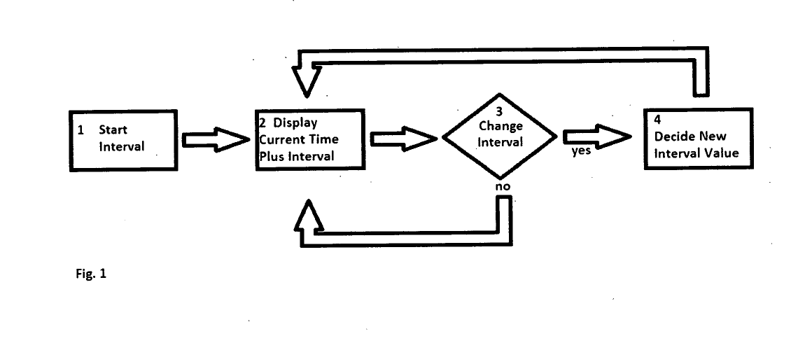

Referring now to the invention in more detail, in FIG. 1 there is shown a flow diagram starting 1 with an interval, or a period of time, then returns the current time plus the interval 2, a decision is made to change the interval 3, if not, go back to returning time plus interval 2, if yes decide what the new interval should be 4 then back to returning time plus the interval 2.

The advantages of the present invention include, without limitation,

A person can do this manually by going to their clock and setting it 10 minutes or some other interval ahead. The disadvantage of that is they will know they set their clock ahead. While it may trick them a few times to be early for work or an appointment, for the most part they will look at their clock and know what the real time is. The advantage of this device is it will trick the person every time. They will not be sure if it is 5, 10, 15, etc minutes ahead, or the correct time. This will make the person have to assume the time stated is at least the current time making them on time or early for appointments.

The preceding examples of the invention have been described to facilitate an understanding of its features, benefits and operation. It will be appreciated, however, that the practical applications of the invention are not limited to these specific embodiments.

1. A Clock for returning time, comprising:
a mechanism for retrieving current time; and a mechanism for retrieving a time; wherein said retrieved current time is combined with said time returning at least the said current time.

2. The invention of claim 1 further comprising a mechanism for retrieving a second time; wherein when said retrieved current time equals said second time, then said time can be changed.

3. A method for returning time comprising:
having a unit of time, then returning the current time combined with said unit of time, a decision is made to change said unit of time, if not, go back to returning said current time combined with said unit of time, if said decision is yes, decide what the said unit of time value should be then back to returning said current time combined with said unit of time.
